(19) United States
(12) Patent Application Publication
(10) Pub. No.: US 2007/0064964 A1
(43) Pub. Date: Mar. 22, 2007

(54) Flat panel speaker assembly

(76) Inventor: Kwun-Wing W. Cheung, Shoreline, WA (US)

Correspondence Address: KLEIN, O'NEILL & SINGH, LLP, 43 CORPORATE PARK, SUITE 204, IRVINE, CA, 92606, US

(21) Appl. No.: 11/229,278

(22) Filed: Sep. 16, 2005

(51) Int. Cl. H04R 25/00

(52) U.S. Cl. 381/323; 381/324

(57) ABSTRACT

A speaker assembly which includes a first diaphragm, a second diaphragm and a driver operationally positioned in an enclosure formed by the first diaphragm and the second diaphragm. The second diaphragm is made of a material composition which allows it to block sound energy, and reflect sound energy along to the first diaphragm.

### BACKGROUND OF THE INVENTION

1. Field of the Invention

This invention relates to speakers, and more particularly, but not exclusively, to flat panel speakers used in public address systems.

2. Background

Audio speakers come in different configurations. Generally, an audio speaker is a device which takes an electrical signal and translates it into physical vibrations, which create sound energy.

A typical speaker configuration uses a driver or exciter that produces sound energy by rapidly pushing and pulling in a piston-like action, a light weight diaphragm, typically fashioned into a “cone” shape. The cone shaped diaphragm is usually made of paper, plastic or metal, and is attached to a suspension module. The cone shaped geometry is used to create a rigid mechanical structure that can be kept light weight. The cone shape provides rigidity, which is important to ensure that the diaphragm can be effectively driven by the driver.

The suspension module is a rim of flexible material or a specially contoured shape of the same cone material that allows the cone to move. The suspension module is attached to the driver's metal frame, called the basket, and controls the cone diaphragm's maximum amplitude.

The narrow end of the cone is connected to a voice coil. The voice coil is attached to the basket by a suspension spring of the voice coil, also known as a spider. The spider holds the coil in position within a magnetic gap, but allows the coil to move freely back and forth.

Unfortunately, the cone type speaker assembly can be hard to install in an aircraft interior, since the loudspeaker assembly height can be high, such as between 2 to 3 inches. The speaker assembly may also be heavy and require a speaker grill. In addition, a cone diaphragm speaker has narrow angle sound projection and is therefore, directional, which does not provide adequate coverage in an aircraft interior.

For public address (PA) speaker applications, flat panel speakers have many advantages over cone type speakers. For example, flat panel speakers provide dispersion of over 120 de- grees versus a cone speaker, which has a dispersion of about 80 degrees. The flat panel speaker also has no on-axis beaming problem and can be made to blend into specific architecture and thus be virtually “invisible”.

However, when efficiency is a concern (for example, in an airplane PA application it is desirable to that the speaker have low power consumption to minimize the impact keep on emergency battery package weight), the typical flat panel speaker is less efficient than conventional cone speakers due to the difference of the “moving mass” between the two speaker designs.

Conventional cone speakers have the strength advantage provided by the geometry of the light weight paper cone diaphragm. Flat panel speakers have a flat diaphragm, which provides no specific geometrical advantage to help strengthen the diaphragm. The soft flat diaphragm creates self canceling, which does not provide good and effective audio performance. To reinforce the flat diaphragm structure, more solid and thicker materials must be used, such as a sandwich lay-up (i.e. honey comb, foam, flute structure, or even solid acrylic board etc). However, these flat diaphragm reinforcing materials add 20 to 100 times the weight relative to paper cone speakers, which lowers the speaker's efficiency.

Unfortunately, it has been shown that even using the lightest available flat panel diaphragm materials available, such as polyester foam board, the flat speaker diaphragm is still at least 10 times heavier than conventional cone speaker diaphragms, which causes a 6 to 12 dB decrease audio level performance than the highest efficiency cone speaker. In addition, the flat panel speakers have poor high frequency response, which starts to roll off as early as from 800 Hz, due to an inappropriate material flexibility coefficient.

Therefore, there is a need for a speaker assembly, which overcomes the restrictive nature of cone type speaker assemblies and the inefficiencies associated with conventional flat panel speakers, provides optimum sound quality, is cost effective and is easy to install/maintain.

### SUMMARY OF THE INVENTION

The present invention provides an isobaric flat panel speaker assembly which solves the inefficiencies of conventional flat panel speakers.

In the present invention, the flat panel speaker assembly captures otherwise unused audio energy, which generally escapes from the back side of conventional flat panel speaker configurations. The present invention converts the escaping audio energy to right phase and tunes it to a preferred frequency range. For example, in a PA application in an aircraft interior, the mid frequency range of between 300 Hz and 1 KHz is desired. The escaping audio energy is tuned to this audio frequency range and then redirected towards the front side of the speaker providing a higher output performance.

In one aspect of the invention a speaker assembly is provided which includes a first diaphragm, a second diaphragm, and a driver operationally positioned in an enclosure formed by the first diaphragm and the second diaphragm. The second diaphragm is made of a material composition which allows it to block sound energy, and reflect sound energy back to the first diaphragm.

In another aspect of the invention, an aircraft is provided which includes an audio system. The audio system includes an input device, an amplifier; and a speaker assembly. The speaker assembly includes a first diaphragm and a second diaphragm, where the second diaphragm has a material composition which allows it to block sound energy and reflect sound energy to said first diaphragm.

In tests, an isobaric flat panel speaker assembly of the present invention was shown to boost the audio output performance by about 4 to 8 dB. With this boost in audio output, the flat panel speaker of the present invention is capable of the same average level of performance efficiency as high efficiency cone speakers.

The flat panel speaker assembly of the present invention can be plugged into a mating panel structure formed into an aircraft bulkhead during the bulkhead assembly process. Once the aircraft interior is completed, there is no visual impact on the appearance of the interior bulkheads. Moreover, because of the modular nature of the speaker assembly, repair and maintenance of the flat panel speaker can be accomplished with minimal impact to the aircraft bulkhead.

Additional advantages, objects, and features of the invention will be set forth in part in the detailed description which follows. It is to be understood that both the foregoing general description and the following detailed description are merely exemplary of the invention, and are intended to provide an overview or framework for understanding the nature and character of the invention as it is claimed.

### BRIEF DESCRIPTION OF THE DRAWINGS

The accompanying drawings are included to provide further understanding of the invention, illustrate various embodiments of the invention, and together with the description serve to explain the principles and operation of the invention. In the drawings, the same components have the same reference numerals. The illustrated embodiment is intended to illustrate, but not to limit the invention. The drawings include the following Figures:

FIG. 1 is a block diagram of a PA system in accordance with an embodiment of the present invention;

FIG. 2 is a simplified cross-sectional view of the flat panel speaker assembly in accordance with an embodiment of the present invention

FIG. 3 is a perspective view of a mounted flat panel speaker assembly representative of test models used in accordance with embodiments of the present invention;

FIG. 4 is a block diagram of an aircraft using the speaker configuration in accordance with an embodiment of the present invention.

### DETAILED DESCRIPTION OF THE INVENTION

To facilitate an understanding of the present invention, the general architecture and operation of an audio system (for example, a PA system) will be described. The specific architecture and operation of the present invention will then be described with reference to the general architecture.

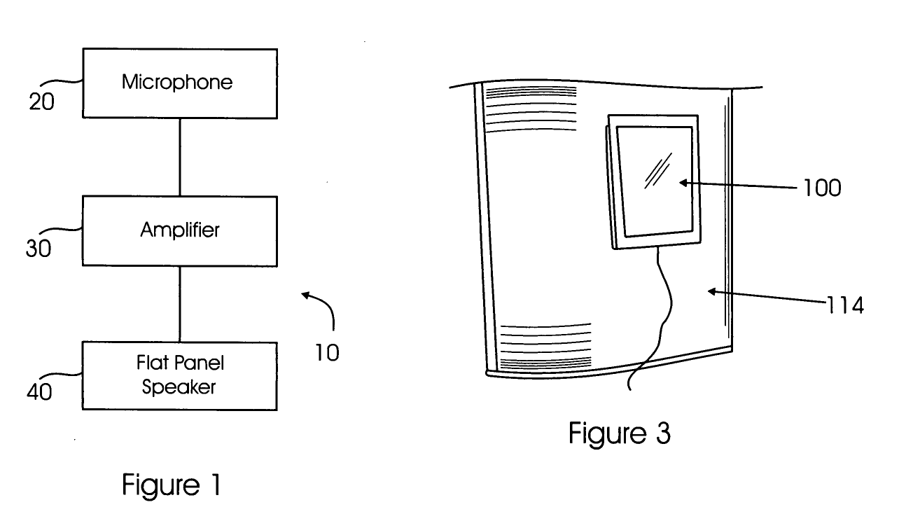

FIG. 1 shows a block diagram of a typical PA system 10 used in an aircraft, according to one aspect of the present invention. PA system 10 includes a microphone or similar audio input device 20 that is capable of receiving an audio input and converting it into an electrical signal, and an amplifier 30, which is used to amplify the electrical signals. PA system 10 uses a speaker assembly, such as flat panel speaker assembly 40 of the present invention to convert the amplified electrical signals into sound waves.

It is noteworthy that although FIG. 1 is used to show an example of a typical PA system, the adaptive aspects of the present invention are not limited to a PA system. The speaker configuration/design/structure described below may be used with any audio system.

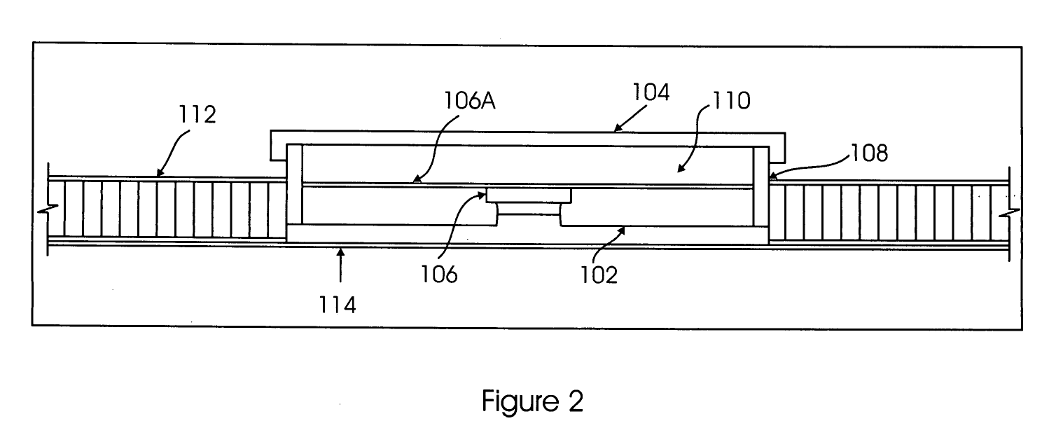

FIG. 2 is a simplified cross-sectional view of a flat panel speaker assembly 100 (hereinafter “speaker assembly 100 ”) in accordance with an embodiment of the present invention. Speaker assembly 100 includes main diaphragm 102, secondary diaphragm 104, and driver 106. A wall structure couples main diaphragm 102 and secondary diaphragm 104 together forming a shallow enclosure 108, defining a gap 110 formed between the two diaphragms, in which driver 106 is positioned. Diaphragms 102 and 104 can be formed in any suitable shaped, such as round or rectangular shapes, and can be large or small depending on the application.

Driver 106 is safely secured and strategically positioned in speaker assembly 100 to assure secure coupling conditions between driver 106 and main diaphragm 102, and to ensure optimum performance conditions. Structure 106A supports and/or locates the driver assembly 106 in the proper position. In accordance with an embodiment of the present invention, secondary diaphragm 104 is free from physical contact with driver 106. Driver 106 is offset from second diaphragm 104 by gap 110. In one embodiment, the distance between diaphragms 102 and 104, and thus the height of speaker assembly 100, is about 1 to 2 inches.

Speaker assembly 100 can be installed, for example, by inserting the entire speaker assembly 100 into a pre-cut hole on a ceiling panel 112 during a lay up process (i.e. during bulkhead fabrication). Speaker assembly 100 may be glued or similarly mounted into panel 112 using conventional speaker mounting means. A covering 114, such as a laminate covering, may be used to cover speaker assembly 100, making speaker assembly 100 virtually invisible to the interior of the aircraft.

In one embodiment, main diaphragm 102 and laminate covering 114 are designed to operate together in audio terms to produce any desired PA quality performance. In this embodiment, the weight, stiffness, rigidity and thickness of laminate covering 114 may be modified to provide optimum sound quality. For example, the thickness of the laminate covering may be determined by a progressive thinning process where the thickness is decreased and each thinning step is followed by an audio test to verify optimum sound quality results. It is noteworthy that the present invention is not limited to any particular material or thickness. The thickness depends on the density of laminate covering 114 and also on the overall diameter of speaker assembly 100.

In operation, a typical flat panel speaker emits audio energy equally on both sides of its respective flat diaphragm. In accordance with an embodiment of the present invention, speaker assembly 100 operates to redirect the “rear directed” or “back firing” audio energy to benefit the “front directed” or “front firing” audio energy, thus, increasing the overall dB level output of speaker assembly 100.

Speaker assembly 100 is not a coherent speaker that works by pumping air in and out in a coherent manner, thus, the function of redirecting audio energy is not accomplished by phase tuning or speaker cabin air pressure modification (unlike a cone speaker assembly). Rather, the redirection of the audio energy is accomplished by means of resonant and reflection tuning, controlled primarily by the function of secondary diaphragm 104, and its distance from main diaphragm 102. Details of the redirection of audio energy in accordance with the present invention are described below.

As described above, speaker assembly 100 has dual diaphragms—main or active diaphragm 102 and secondary or passive diaphragm 104. Unlike some consumer sub-woofers that use a passive radiator to utilize woofer energy more effectively, passive diaphragm 104 of speaker assembly 100 is not intended to emit or radiate sound outward (i.e. to the rear of the speaker).

Referring again to FIG. 2, secondary diaphragm 104, although referred to as a diaphragm, can be described as a functioning baffle of enclosure 108. The significance of this description, is that generally, speaker baffles are made of a rigid material that can block sound energy from radiating out of the speaker enclosure. Thus, in accordance with an embodiment of the present invention, passive diaphragm 104 is a stiffer diaphragm than the soft or flexible active diaphragm 102.

For ease of understanding, below is a detailed description of a particular embodiment of the present invention, which is not intended to limit the invention in any manner.

Accordingly in this exemplary embodiment, speaker assembly 100 can include active diaphragm 102, which is made of one ply of 120 glass and one ply of glass fly Screen on separate sides of a Nomax honeycomb core having a thickness of about 0.12 inches. The size and material composition of active diaphragm 102 in this embodiment is a result of a timely research and testing—matching (installed) with the audio attributes of a 0.375 (⅜″) thick ceiling laminate 114.

In this embodiment, the use of active diaphragm 102 alone performs in audio quality tests at about 8 dB less efficiency than production airplane PA speakers. Using diaphragm 102 provides higher efficiency and dynamic performance than conventional flat panel speakers.

In accordance with the present invention, the addition of passive diaphragm 104 to speaker assembly 100 increases the output efficiency. It is noteworthy that the composition of passive diaphragm 104 is significant to the successful implementation of the present invention. Improper material uses may actually reduce the efficiency of active diaphragm 102.

In this embodiment, passive diaphragm 104 can be made of one ply of 120 glass and one ply of 181 glass on separate sides of a Nomax honeycomb core. Lab tests have verified that the combination of dissimilar composition diaphragms 102 and 104 boosted the audio output by an additional 4-8 dB of speaker output at a range of about 500 Hz to 11 kHz.

In this embodiment, passive diaphragm 104 is about 30% to 75% stiffer than active diaphragm 102. Being stiffer, the mass of diaphragm 104 is not necessary so much heavier than active diaphragm 102. In one aspect, the mass is about 10% heavier.

Given the structure described in FIG. 2, in operation, sealed enclosure 108 traps most back firing audio energy. The back firing audio energy from active diaphragm 102 activates passive diaphragm 104 to vibrate. However, since passive diaphragm 104 is a stiffer diaphragm, it blocks sound energy rather than radiates sound energy.

In addition to blocking sound energy, passive diaphragm 104 reflects sound energy back to active diaphragm 102. At the same time, the material composition of passive diaphragm 104 creates a range of desired resonance in reaction to the performing audio frequencies and level. The resonance, along with the reflection of sound energy, and the tailored distance between both diaphragms 102 and 104, can assure additional frequency output of between about 500 Hz -11 kHz of speaker assembly 100.

Test data confirms the significant improvement of the dB output of speaker assembly 100. FIG. 3 is a perspective view of a mounted flat panel speaker assembly 100 representative of a test model incorporating the embodiment of the present invention described in FIG. 2.

Table 1 summarizes the results of an on-axis test performed using this embodiment of speaker assembly 100. On-axis measurements were made at varying frequencies of a speaker assembly having active diaphragm 102 only and a speaker assembly 100 having an active diaphragm 102 and a passive diaphragm 104 positioned in enclosure 108 with a predetermined gap 104 in accordance with an embodiment of the present invention.

TABLE 1

| | Frequency | | | | | |
|---|---|---|---|---|---|---|
| | 125 | 250 | 500 | 1000 | 2000 | 4000 |
| with passive | 54.6 | 65.8 | 76 | 80.4 | 77.9 | 74.5 |
| diaphragm | | | | | | |
| without | 54.8 | 67.7 | 72.6 | 76 | 77.7 | 74 |
| passive | | | | | | |
| diaphragm | | | | | | |

The on-axis data in Table 1 shows an increase, for example, of 4.4 dB at 1 kHz with passive diaphragm 104.

Some test were conducted which compared speaker assembly 100 with a typical cone speaker, at 60 degrees off-axis at a two meter distance. Speaker assembly 100 measured more dB output than the cone speaker due to the weak dispersion nature (less than 90 degrees) of cone speakers, and the wider dispersion (over 120 degrees) capability of speaker assembly 100. The wider angle coverage capability of speaker assembly 100 is particularly beneficial for covering seats in the interior of an aircraft that are located away from the center aisle (i.e. window seats). Conventional cone speaker would have to be driven much louder in order to cover wider area, at a cost of greater amplifier power, and may become unbearable for passengers sitting along the axis of the speaker.

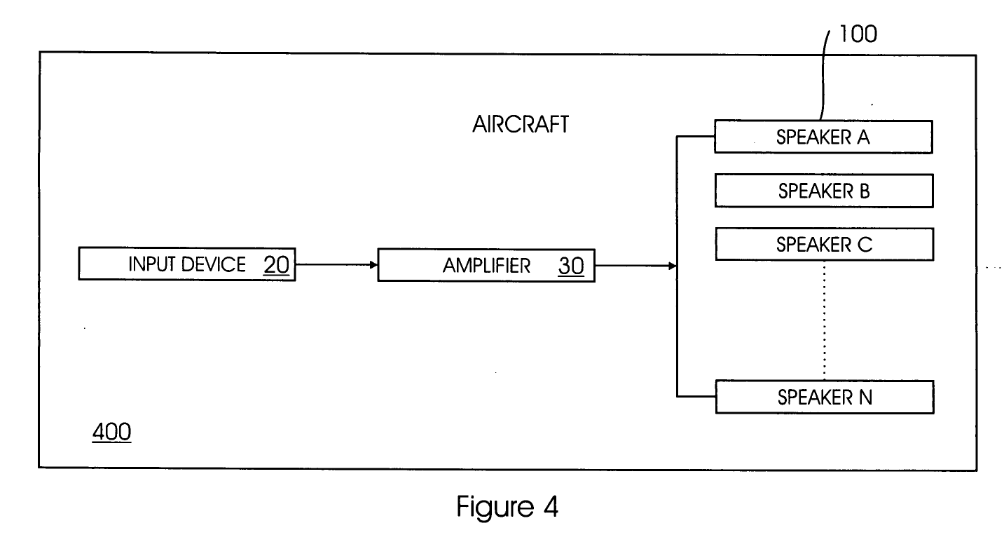

FIG. 4 shows a block diagram of an aircraft 400 having PA system 10 incorporated therein. In this embodiment, aircraft 400 includes plural speaker assemblies 100 (shown as Speaker A, Speaker B. . . Speaker N). The plurality of speaker assemblies 100 receive an electrical signal from amplifier 30 that receives an input from microphone 20 and produce optimum sound within at least a frequency range of 300 Hz to 5,000 Hz with efficiency of 1 watt (root mean square (“RMS”) to produce an average of 80-95 dB audio level. In another embodiment, speaker assemblies can be adapted to further produce acceptable audio in a frequency range that is both lower than 300 Hz and/or higher than 5,000 Hz. However, low frequency extension range may have to be controlled (trim or limited) to avoid possible airplane interior architecture resonance. It is noteworthy that the system in aircraft 400 may be used in plural applications, where flat panel speakers can be used.

As will by now be evident to persons of ordinary skill in the art, many modifications, substitutions and variations can be made in and to the materials used for the reliable, low-cost, speaker assembly 100 of the present invention without departing from its spirit and scope. It is understood, that the speaker system of the present invention may find use in vehicles or general domestic and commercial applications other than airplanes. All such uses are within the scope of the present invention.

Accordingly, the scope of the present invention should not be limited to the particular embodiments illustrated and described herein, as they are merely exemplary in nature, but rather, should be fully commensurate with that of the claims appended hereafter and their functional equivalents. What is claimed is:

1. A speaker assembly comprising:
a first diaphragm;
a second diaphragm; and
a driver operationally positioned in an enclosure formed by said first diaphragms and said second diaphragms,
said second diaphragm having a material composition causing it to block sound energy and reflect sound energy to said first diaphragm.

2. The speaker assembly of claim 1, wherein said first diaphragm is an active diaphragm configured to radiate sound energy.

3. The speaker assembly of claim 1, wherein said first diaphragm comprises a material composition including one ply of 120 glass and one ply of glass Fly Screen layered on separate sides of a Nomax honeycomb core.

4. The speaker assembly of claim 1, wherein said first diaphragm comprises a thickness of about 0.12 inches.

5. The speaker assembly of claim 1, wherein said second diaphragm comprises a material composition including one ply of 120 glass and one ply of 181 glass layered on separate sides of a Nomax honeycomb core.

6. The speaker assembly of claim 1, wherein said second diaphragm comprises a thickness of about 0.12 inches.

7. The speaker assembly of claim 1, wherein the speaker assembly is installed for use with an audio system.

8. The speaker assembly of claim 1, wherein the speaker assembly is installed for use with a public addressing system of an aircraft.

9. The speaker assembly of claim 1, wherein the second diaphragm is free from contact with said driver.

10. The speaker assembly of claim 1, wherein said enclosure defines a gap between said first diaphragm and said second diaphragm.

11. The speaker assembly of claim 10, wherein said gap comprises a dimension of between about 1 and 2 inches.

12. The speaker assembly of claim 1, wherein the first diaphragm and the second diaphragm are operationally configured to produce sound energy maintained in a frequency range of about 300 Hz to about 5,000 Hz when subject to an appropriate input signal.

13. The speaker assembly of claim 1, further comprising a cover configured to function operationally with the first diaphragm when subject to an input signal.

14. A speaker assembly comprising:
a first diaphragm having a first material composition; and
a second diaphragm having a second material composition configured to form an enclosure with said first diaphragm, which defines a gap therebetween;
said second diaphragm having a material composition causing it to block sound energy, and reflect said sound energy to said first diaphragm causing said first diaphragm to produce sound energy in a frequency range of about 300 Hz to about 1,000 Hz of between about a 80 and 95 dB audio level when subject to an appropriate input signal.

15. The speaker assembly of claim 14, further comprising a driver operationally positioned in said enclosure.

16. The speaker assembly of claim 15, wherein said driver is free from contact with said second diaphragm.

17. The speaker assembly of claim 14, wherein said first diaphragm is an active diaphragm configured to radiate sound energy.

18. The speaker assembly of claim 14, wherein said material rial composition of said first diaphragm comprises one ply of 120 glass and one ply of glass Fly Screen layered on separate sides of a Nomax honeycomb core.

19. The speaker assembly of claim 14, wherein said first diaphragm comprises a thickness of about 0.12 inches.

20. The speaker assembly of claim 14, wherein said material composition of said second diaphragm comprises one ply of 120 glass and one ply of 181 glass layered on separate sides of a Nomax honeycomb core.

21. The speaker assembly of claim 14, wherein the speaker assembly is installed for use with a public addressing system of an aircraft.

22. The speaker assembly of claim 14, wherein said gap comprises a dimension of between about 1 and 2 inches.

23. The speaker assembly of claim 14, further comprising a cover configured to function operationally with the first diaphragm when subject to an input signal.

24. A mobile platform comprising:
an audio system including:
an input device;
an amplifier; and
a speaker assembly, said speaker assembly including a first diaphragm and a second diaphragm; said second diaphragm having a material composition causing it to block sound energy, and reflect said sound energy to said first diaphragm.

25. The mobile platform of claim 24, wherein the mobile platform is an aircraft.
